(19) United States
(12) Patent Application Publication
(10) Pub. No.: US 2026/0150831 A1
(43) Pub. Date: Jun. 4, 2026

(54) FLAT FOLDING TREE STAND

(71) Applicant: Double Dragon International, Inc., Dubuque, IA (US)

(72) Inventors: Randy L. SCHOFIELD, Humbird, WI (US); Richard D. WALKER, Dubuque, IA (US); Brock M. JENSEN, Dubuque, IA (US); Jackson A. HOGAN, Peosta, IA (US)

(73) Assignee: Double Dragon International, Inc., Dubuque, IA (US)

(21) Appl. No.: 18/967,274

(22) Filed: Dec. 3, 2024

(51) Int. Cl. A01M 31/02

(52) U.S. Cl. CPC A01M 31/02

(57) ABSTRACT

A flat folding tree stand system for mounting to a tree may include a platform, tree mounting arms pivotably connected to opposite sides of the platform and extending rearwardly, a cross brace having opposite end portions pivotably connected to the tree mounting arms, a cross brace carriage pivotably connected to a midportion of the cross brace and movably coupled to the platform for forward and rearward movement along the platform and a retainer to selectively secure the cross brace carriage at a forward position with the cross brace in a lower retracted state and a rearward position with the cross brace in a raised extended state.

### BACKGROUND

Tree stands are often used for hunting and wildlife observation. Tree stands typically include a platform upon which a person may stand. Some tree stands additionally include a secondary platform that serves as a seat. As such tree stands are often used in remote areas, transporting such tree stands and other gear is often difficult.

### BRIEF DESCRIPTION OF THE DRAWINGS

FIG. 1 is a side view schematically illustrating portions of an example flat folding tree stand system in an extended upright state.

FIG. 2 is a top view schematically illustrating portions of the example flat folding tree stand system of FIG. 1 in the extended upright state.

FIG. 3 is a side view schematically illustrating portions of the example flat folding tree stand system of FIG. 1 in a retracted folded state.

FIG. 4 is a top view schematically illustrating portions of the example flat folding tree stand system of FIG. 1 in the retracted folded state.

FIG. 5 is a fragmentary side view illustrating portions of an example flat folding tree stand system in an extended upright state.

FIG. 6 is a sectional view of the example flat folding tree stand system of FIG. 5.

FIG. 7 is a sectional view of an alternative variation of the example flat folding tree stand system of FIG. 6.

FIG. 8 is a fragmentary side view illustrating portions of an example flat folding tree stand system in an extended upright state.

FIG. 9 is a sectional view of the example flat folding tree stand system of FIG. 8.

FIG. 10 is a sectional view of an alternative variation of the example flat folding tree stand system of FIG. 9.

FIG. 11 is a sectional view illustrating portions of an example flat folding tree stand system in an extended upright state.

Eager 12 is a sectional view illustrating portions of the example flat folding tree stand system of FIG. 11.

FIG. 13 is a top view illustrating portions of the example flat folding tree stand system of FIG. 11.

FIG. 14 is a front perspective view of an example flat folding tree stand system in an extended upright state.

FIG. 15 is a front perspective view of the example flat folding tree stand system of FIG. 14 in the extended upright state.

FIG. 16 is an enlarged fragmentary view illustrating portions of the example flat folding tree stand system of FIG. 11.

FIG. 17 is an enlarged fragmentary bottom perspective view illustrating portions of the example flat folding tree stand system of FIG. 11 in the extended upright state.

FIG. 18 is a top perspective view illustrating portions of the example flat folding tree stand system of FIG. 11 in a retracted folded state.

FIG. 19 is a bottom perspective view illustrating portions of the example flat folding tree stand system of FIG. 11 in the retracted folded state.

FIG. 20 is a top perspective view of an example two platform flat folding tree stand system having an upper flat folding tree stand system in an extended upright state and a lower flat folding tree stand system in an extended upright state.

FIG. 21 is a side view of the example two platform flat folding tree stand system of FIG. 20 in a stacked configuration with the upper flat folding tree stand system in a retracted folded state and the lower flat folding tree stand system in a retracted folded state.

FIG. 22 is a top perspective view illustrating portions of an example flat folding tree stand system having a pair of guides.

FIG. 23 is a bottom perspective view of the flat folding stand system of FIG. 22.

FIG. 24 is a rear perspective view of the flat folding tree stand system of FIG. 22.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION OF EXAMPLES

Disclosed are example flat folding tree stand systems configured to be folded to a substantially flat, more compact collapsed state when being transported. For purposes of this disclosure, the term “flat” with respect to the folded state of the tree stands means that any tree mounting arms or braces of the tree stand may be collapsed so as to extend in one or more planes that are substantially parallel to the plane of the platform of the tree stand or that extend in one or more planes that extend at an angle of no greater than 20 degrees with respect to the plane of the platform. As result, the vertical height of the tree stand system, when collapsed or folded, is reduced to facilitate easier transport such as when the tree stand is being transported to a remote location for hunting or wildlife observation or such as when the tree stand is being packaged, shipped or stored.

In some implementations, the example flat folding tree stand systems are actuatable between a raised extended, in use state and a lower retracted state. The example flat folding tree stand systems may be selectively retained in either of the two positions through manual manipulation of a single retainer. As result, securement of the tree stand in either of the two positions is less complex and faster.

In some implementations, the example flat folding tree stand systems comprise a platform, tree mounting arms pivotably connected to opposite sides of the platform and extending rearwardly, a cross brace having opposite end portions pivotably connected to the tree mounting arms, a cross brace carriage pivotably connected to a midportion of the cross brace and movably coupled to the platform for forward and rearward movement along the platform, and a retainer to selectively secure the cross brace carriage at a forward position with the cross brace in a lower retracted state and a rearward position with the cross brace in a raised extended state.

In some implementations, the retainer may comprise a threaded fastener, such as a screw, bolt or the like which interacts with a corresponding threaded opening in a bore or nut. Some implementations, the retainer may comprise a removable pin. In some implementations, the retainer may comprise a pin that is regionally biased to an inserted state by a spring, wherein the pin may be pulled against the spring to withdraw the pin.

In some implementations, the example flat folding tree stand systems may comprise a guide for guiding the forward and rearward movement of the cross brace carriage along the platform. In some implementations, the guide may be in the form of an elongate slot formed in the platform, wherein portions of the carriage or portions of the retainer slide within the slot to guide movement of the carriage. In some implementations, the guide may be in the form of a tubular interior which slidably receives portions of the carriage of portions of the guide. In in some implementations, the guide may comprise an elongate bolt or bar that slidably passes through a passage formed within the carriage, wherein the carriage slides along the rod or bar. In such implementations, the retainer may releasably engage portions of the platform for releasably engaging portions of the rod or bar to secure the carriage in place along the rod or bar.

In some implementations, the example flat folding tree stand systems may be used without any other platforms, wherein the platform of the system provides a surface upon which a person may stand or be seated. In some implementations, the flat folding tree stand systems may be used with an additional upper platform upon which a person may be seated while resting his or her feet on the platform of the flat folding tree stand system. In some implementations, a pair of flat folding tree stand systems may be utilized together, wherein a first system provides a lower platform upon which a person may stand or rest his or her feet and wherein a second system provides an upper platform upon which the person may be seated. In such implementations, both the first system and the second system may be substantially identical, but wherein the platform of second system which serves as the upper platform may have a smaller profile as compared to the platform of the first system serving as a lower platform. In such implementations, the second system may additionally comprise a pad, cushion or panel for covering the platform which is to serve as a seat.

For purposes of this disclosure, the term “coupled” shall mean the joining of two members directly or indirectly to one another. Such joining may be stationary in nature or movable in nature. Such joining may be achieved with the two members or the two members and any additional intermediate members being integrally formed as a single unitary body with one another or with the two members or the two members and any additional intermediate member being attached to one another. Such joining may be permanent in nature or alternatively may be removable or releasable in nature. The term “operably coupled” shall mean that two members are directly or indirectly joined such that motion may be transmitted from one member to the other member directly or via intermediate members.

For purposes of this disclosure, the phrase “configured to” denotes an actual state of configuration that fundamentally ties the stated function/use to the physical characteristics of the feature proceeding the phrase “configured to”.

For purposes of this disclosure, the term “releasably” or “removably” with respect to an attachment or coupling of two structures means that the two structures may be repeatedly connected and disconnected to and from one another without material damage to either of the two structures or their functioning.

FIGS. 1-4 illustrate portions of an example flat folding tree stand system 20. The example flat folding tree stand system 20 is configured to be folded to a substantially flat, more compact collapsed state when being transported. As result, the vertical height of the tree stand system 20, when collapsed or folded, is reduced to facilitate easier transport such as when the tree stand is being transported to a remote location for hunting or wildlife observation or such as when the tree stand is being packaged, shipped or stored.

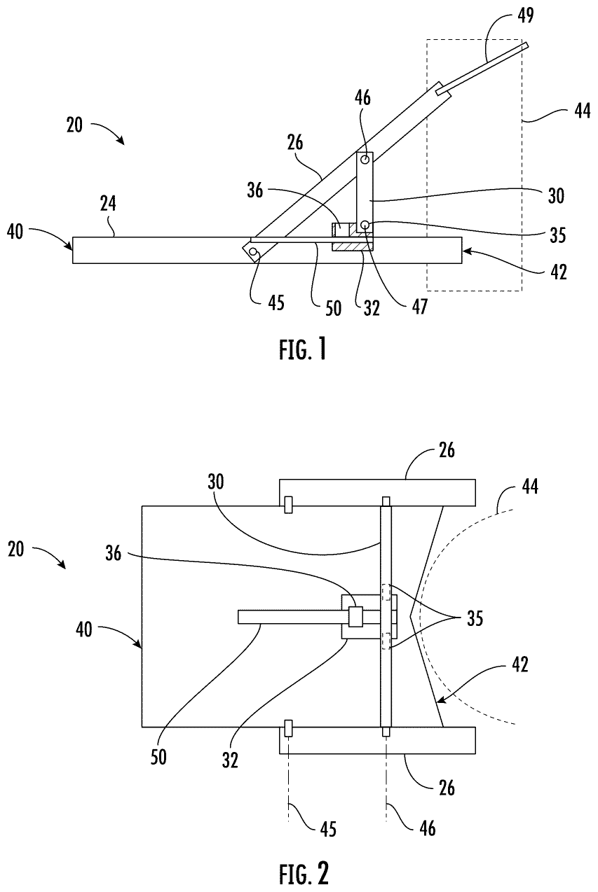

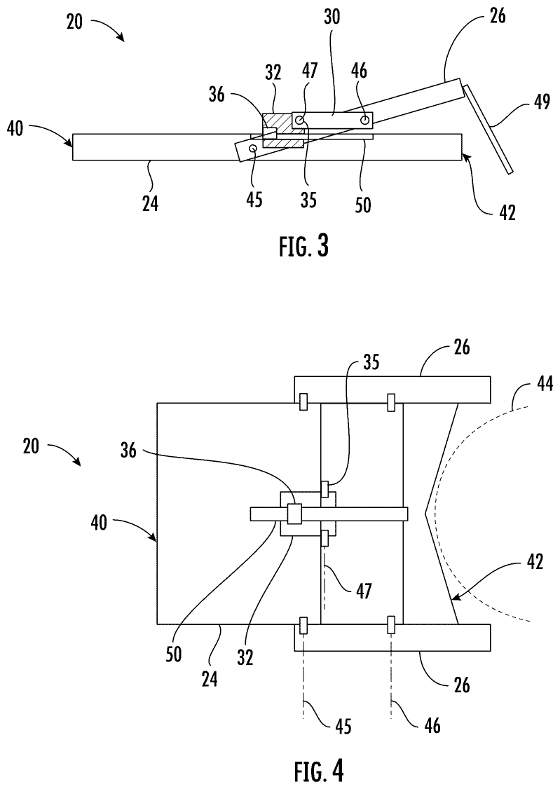

The example flat folding tree stand system 20 is actuatable between a raised extended, in use state as shown in FIGS. 1 and 2 and a lower retracted state shown in FIGS. 3 and 4. The example flat folding tree stand system 20 is selectively retained in either of the two positions through manual manipulation of a single retainer. As result, securement of the tree stand in either of the two positions is less complex and faster.

The example flat folding tree stand system 20 comprises platform 24, tree mounting arms 26, cross brace 30, cross brace carriage 32, and retainer 36. Platform 24 comprises a structure having a substantially flat upper surface. Platform 24 has a front edge 40 and a rear edge 42. Rear edge 42 may be configured or shaped so as to abut against the generally circumferential profile of a tree trunk or branch 44 (shown in broken lines). In the example illustrated, rear edge 42 is concave for receiving a portion of tree 44. In some implementations, rear edge 42 has a V-shaped recess as shown. In some implementations a rear edge 42 may be provided with a series of teeth for further facilitating the gripping of tree 44.

In some implementations, platform 24 may be form from a metal, such steel or aluminum. In some implementations, platform 24 may be perforated or comprise a network, grid or lattice of rods or bars such that a majority of the platform 24 is perforate or open celled to reduce weight. In some implementations, platform 24 may be formed by welding. In other implementations, platform 24 may be formed by casting or other manufacturing techniques.

In some implementations, platform 24 provides a surface upon which a person may support his or her weight during standing. In implementations where system 20 is used with an additional lower platform, platform 24 serves as a seat. In implementations where platform 24 serves as a seat, platform 24 may have a smaller outer profile to facilitate seating of a person with his or her feet extending forward of platform 24 for resting upon the additional lower platform. In such implementations, system 20 may additionally comprise a pad, cushion or panel.

Tree mounting arms 26 are pivotally connected to opposite sides of platform 24 at one end and are configured to be connected to a tree wrapping member 49 at the other end. Tree wrapping member 49 may comprise a cable, belt, band, rope or other flexible member. Although illustrated as being generally linear, to mounting arms 26 may have a right different shapes and configurations.

Cross brace 30 (schematically shown) comprises a member that extends between and joins tree mounting arms 26. Cross brace 30 supports tree mounting arms 26 in their raised positions shown in FIG. 1. Opposite ends or sides of cross brace 30 are each pivotally connected to respective tree mounting arms 26. A middle portion of cross brace 30 is pivotally connected to cross brace carriage 32, such as with an axle or pivot pin 35. In the example illustrated, tree mounting arms 26 are pivotable relative to platform 24 about axis 45. Cross brace 30 is pivotable relative to tree mounting arms 26 about axis 46 and is pivotal relative to carriage 32 about axis 47. Each of axes 45, 46, and 47 are parallel to one another.

Cross brace carriage 32 (schematically illustrated) comprises a member or mechanism configured to movably carry cross brace 30 relative to platform 24 into forward and rearward directions towards and away from edges 40 and 42. As indicated above, cross brace carriage 32 is pivotably connected to cross brace 30. Cross brace carriage 32 may be guided in the forward direction or the rearward direction by a guide 50.

Guide 50 comprises an arrangement of surfaces that engage corresponding surfaces of carriage 32 to restrict or limit movement of carriage 32 in forward and rearward directions. As will be described hereafter respect to specific implementations, guide 50 may be in the form of an elongate slot formed in the platform 24, wherein portions of the carriage 32 or portions of the retainer 36 slide within the slot to guide movement of the carriage. In some implementations, the guide 50 may be in the form of a tubular interior which slidably receives portions of the carriage 32. In some implementations, the guide 50 may comprise an elongate bar or rod that slidably passes through a passage formed within the carriage 32, wherein the carriage slides along the rod or bar. In such implementations, the retainer 36 may releasably engage portion of the platform 24 for releasably engaging portions of the rod or bar to secure the carriage 32 in place along the rod or bar.

Retainer 36 selectively secures the cross brace carriage 32 at (1) a forward position with the cross brace 30 in a lower retracted state as shown in FIGS. 3 and 4 and (2) a rearward position with the cross brace in a raised extended state as shown FIGS. 1 and 2. In some implementations, the retainer 36 may comprise a threaded fastener, such as a screw, bolt or the like which interacts with a corresponding threaded opening in a bore or nut associated with platform 24 and/or guide 50. In some implementations, the retainer 36 may comprise a pin which is removably inserted into a bore or detent so as to concurrently engage both carriage 32 and platform 24/guide 50 to releasably lock carriage 32 relative to guide 50 and/or platform 24. In some implementations, the retainer 36 may comprise a pin that is resiliently biased to an inserted state by a spring, wherein the pin may be pulled against the spring to withdraw the pin out of engagement with at least one of carriage 32 and platform 24/guide 50.

As shown by FIGS. 1 and 2, carriage 32 may be moved to a rearward location as shown and retained in place at a location so as to support tree support arms 26 in their raised states. Tree wrapping member 49 may extend from end portions of a tree mounting arms 26 to stably support system 20 along tree 44. As shown by FIGS. 3 and 4, system 20 is no longer being used, such as during shipping, storage or transport, retainer 36 may be actuated to release carriage 32, permitting carriage 32 to be moved to the forward position. During movement of carriage 32 in the forward direction, towards edge 40, cross brace 30 pivots about axis 47 relative to carriage 32, and support arms pivot relative to cross brace 30 and platform 24 about axes 46 and 45, respectively. As a result, cross brace 30 and tree support arms 26 collapse towards platform 24 to provide system 20 with a substantially flat profile as seen in FIG. 3. In some implementations, retainer 36 is configured to retain carriage 32 in the forward state to releasably lock system 20 in the collapsed or flat state. In some implementations, retainer 36 may only be configured to releasably lock carriage 32 in the rearward state, not locking carriage 32 in the forward state.

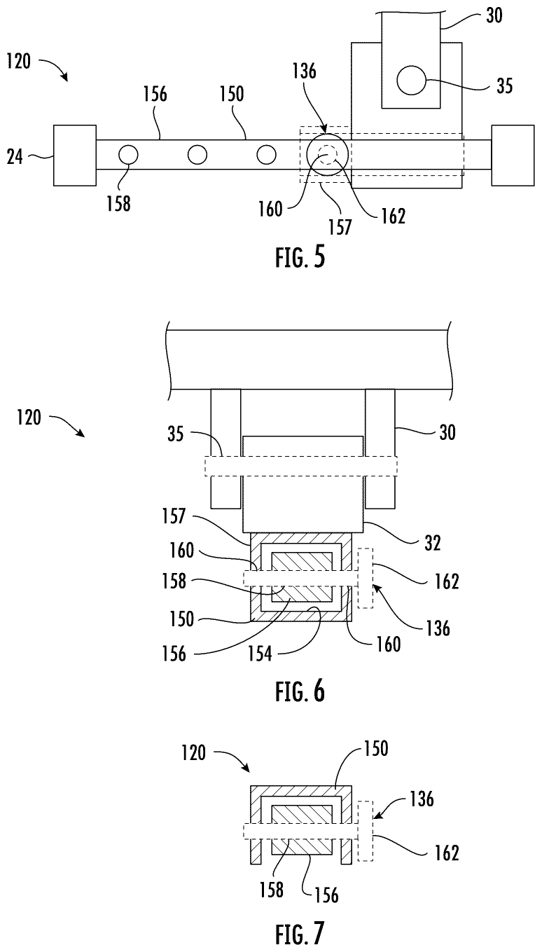

FIGS. 5 and 6 illustrate portions of an example flat folding tree stand system 120. System 120 is similar to system 20 described above except the system 120 specifically comprises guide 150 and retainer 136, particular implementations of guide 50 and retainer 36 described above. Those remaining components of system 120 which correspond to components of system 20 are numbered similarly and/or are shown and described above with respect to FIGS. 1-4.

Guide 150 comprises a pair of cooperating members, an interior passage 154 extending through or otherwise coupled to carriage 32 and elongate bar or rod 156 secured to or provided as part of platform 24. In the example illustrated, carriage 32 may comprise a tubular extension 157 forming a portion of passage 154. Rod 156 extends through passage 154. Carriage 32 is slidable along rod 156, wherein fore and rearward movement of carriage 32 is guided by rod 156.

Retainer 136 comprises a mechanism configured to releasably secure carriage 32 at a selected one of multiple available positions along rod 156. Retainer 136 comprise a set of cooperating members: a series of detents 158 formed in rod 156; an opening 160 formed in a structure coupled to are a part of carriage 32; and a pin 162. In the example illustrated, opening 160 is formed in the tubular extension 157. Pin 162 passes through opening 160 into engagement with a selected one of detents 158 at a selected position along rod 156. In the example illustrated by FIG. 6, opening 160 passes through both sides of the tubular extension 157 while detent 158 extends completely through rod 156. Pin 162 passes completely through rod 156 and through both of the openings 160.

In other implementations, retainer 136 may have other configurations. For example, pin 162 may extend only through a single opening 160 in tubular extension 157. Pin 162 may not completely pass through rod 156. Rather than comprising bores that completely pass through rod 156, detents 158 may instead comprise concave dimples or depressions in the outer surface of rod 156. In some implementations, pin 162 may be resiliently biased by a spring to the inserted position, when withdrawal of pin 162 requires movement against the bias of the spring. In some implementations, as shown in FIG. 7, tubular extension 157 may extend about a portion of rod 156. In yet other implementations, detents 158 may be omitted, wherein pin 162 frictionally engages a side of rod 156 to retain carriage 32 in place. In such implementations, pin 162 may be replaced with a threaded bolt which is threaded into a threaded bore provided in tubular extension 157, wherein the boltl may be tightened against rod 156 to retain carriage 32 in place. In yet other implementations, pin 162 may be replaced with a bolt that passes through detent 158 and through tubular extension before being secured by a nut.

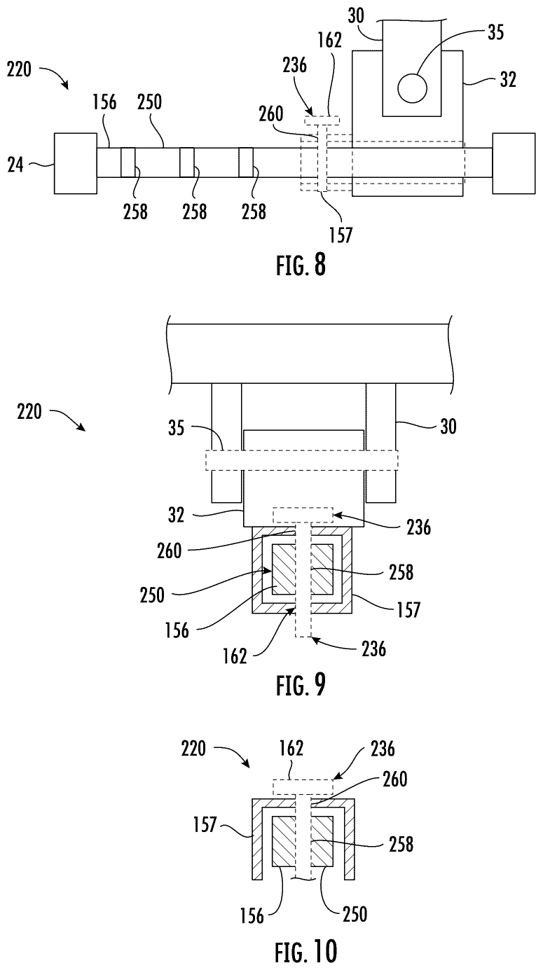

FIGS. 8 and 9 illustrate portions of an example flat folding tree stand system 220. System 220 is similar to systems 20 and 120 described above except that system 220 comprises guide 250 and retainer 236. Those remaining components of system to 20 which correspond to components of systems 20 and 120 are numbered similarly and/or are shown and described above in FIGS. 1-7.

Guide 250 is similar to guide 150 described above except that guide 250 comprises vertically extending detents 258 instead of horizontally extending detents 158 and that guide 250 comprises a vertically extending opening 260 instead of the horizontally extending opening 160 in tubular extension 157. Similar to the operation of system 120, alignment of opening 260 with a particular one of detents 258 and insertion of pin 162 through the pair of aligned openings releasably secures or locks carriage 32 in place along rod 156. As shown by FIG. 10, tubular extension 157, through which opening 260 extends, may partially extend about rod 156.

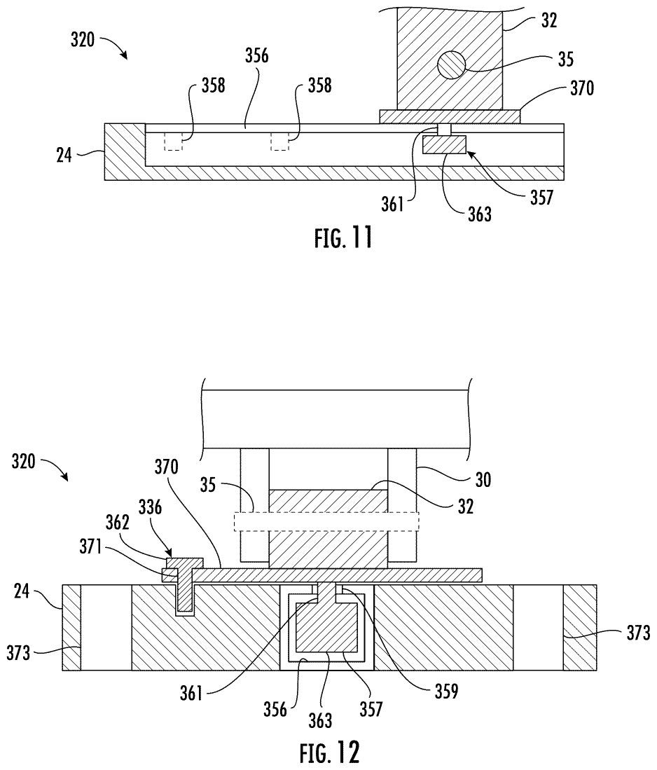

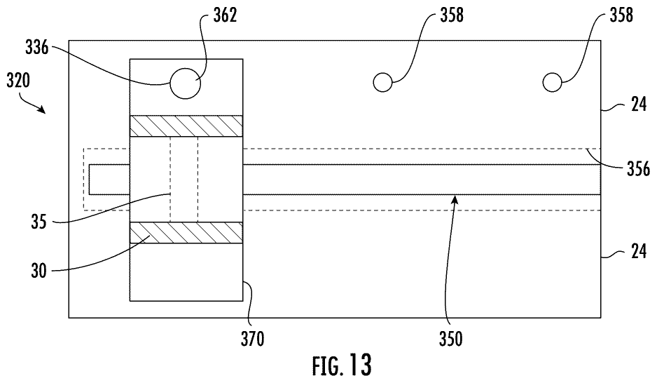

FIGS. 11-13 illustrate portions of an example flat folding tree stand system 320. System 320 is similar to system 20 described above except that system 320 comprises guide 350 and retainer 336. Those remaining components of system 320 which correspond to components of system 20 are numbered similarly and/or are shown and described above with respect to FIGS. 1-4.

Guide 350 comprises channel 356 and slider 357. Channel 356 extends rearwardly and forwardly (longitudinally) along platform 24 and included longitudinally extending slot 359. Guide 350 comprises slider having a neck portion 361 and a head portion 363. Neck portion 361 extends from carriage 32 through slot 359. Head portion 361 is connected to the neck portion 361 and is received within channel 356. Head portion 361 has a dimension greater than that of slot 359 so as to capture and secure carriage 32 with respect to platform 24 for slidable movement along platform 24.

Retainer 336 comprises a deck 370 coupled to and extending laterally from carriage 32. Deck 370 comprises a retention opening 371 extending through deck 370. Retainer 336 further comprises a series of panel detents 358 formed in platform 24 and a retention pin 362. In use, carriage 32 and deck 370 may be moved along platform 24 so as to align aperture 371 with a selected one of detents 358. Upon alignment of aperture 371 with a particular detent 358, retention pin 362 may be passed through apeture 371 into the detent 358 to retain carriage 32 at a selected longitudinal position. As discussed above, carriage 32 may be retained at a rearward position to support cross brace 30 and support arms 26 in the extended in use position shown in FIGS. 1 and 2. Retainer 336 may retained at a forward position to support cross brace 30 and tree support arms 26 in the collapsed or folded state or position shown in FIGS. 3 and 4. To change the positioning of carriage 32 along platform 24 merely involves withdrawing retention pin 362 from a particular detent 358 and reinserting pin 362 into a different one of detents 358. As with pin 162, pin 362 may be resiliently biased in a downward direction, towards platform 24, by spring. As shown by FIG. 12, platform 24 may include a series of perforations or openings 373 such that platform 24 is perforated or open celled for reduced weight.

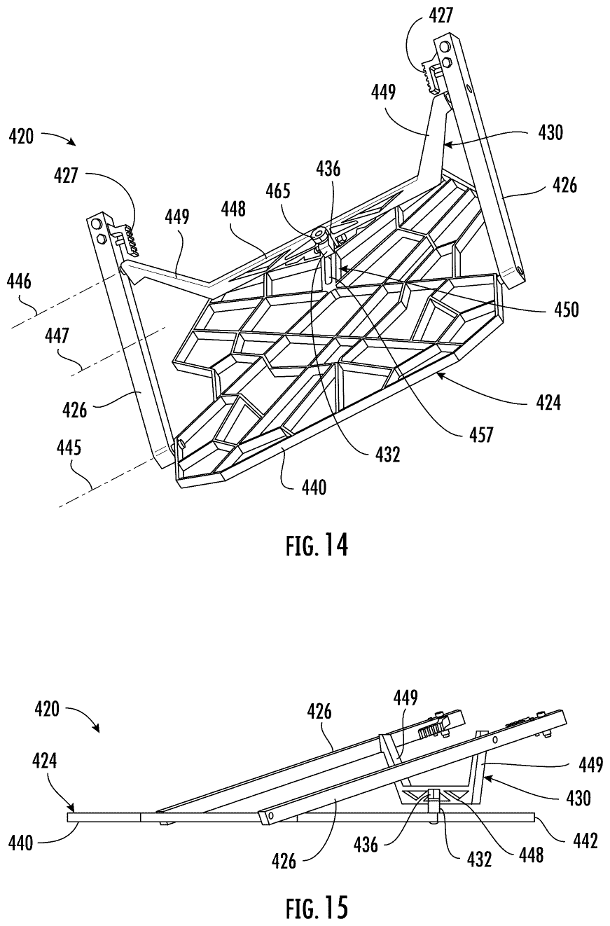

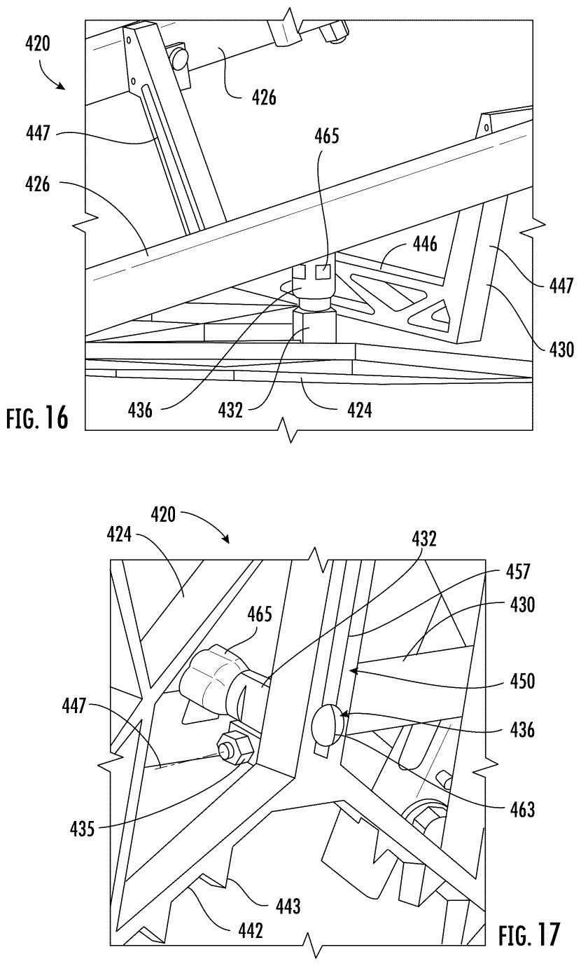

FIGS. 14-19 are perspective views illustrating portions of an example flat folding tree stand system 420. The example flat folding tree stand system 420 is configured to be folded to a substantially flat, more compact collapsed state when being transported. As result, the vertical height of the tree stand system 420, when collapsed or folded, is reduced to facilitate easier transport such as when the tree stand is being transported to a remote location for hunting or wildlife observation or such as when the tree stand is being packaged, shipped or stored.

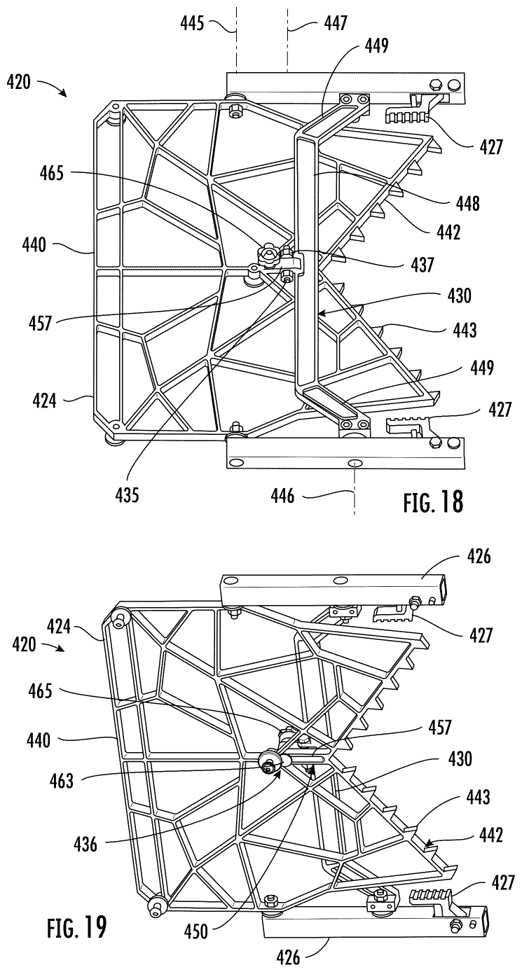

The example flat folding tree stand system 420 is actuatable between a raised extended, in use state as shown in FIGS. 14-17 and a lower retracted state shown in FIGS. 18-19. The example flat folding tree stand system 420 is selectively retained in either of the two positions through manual manipulation of a single retainer. As result, securement of the tree stand in either of the two positions is less complex and faster.

The example flat folding tree stand system 420 comprises platform 424, tree mounting arms 426, cross brace 430, cross brace carriage 432, and retainer 436. Platform 424 comprises a structure having a substantially flat upper surface. Platform 424 has a front edge 440 and a rear edge 442. Rear edge 442 may be configured or shaped so as to abut against the generally circumferential profile of a tree trunk or branch 44 (shown in broken lines in FIGS. 1 and 2). In the example illustrated, rear edge 442 is concave for receiving a portion of tree 44. In some implementations, rear edge 442 has a V-shaped recess as shown. In the illustrated example, rear edge 442 is provided with a series of teeth 443 for the gripping of tree 44.

In some implementations, platform 424 may be form from a metal, such steel or aluminum. In the example illustrated, platform 424 is perforated or comprises a network, grid or lattice of rods or bars such that a majority of the platform 424 is perforated or open celled to reduce weight. In some implementations, platform 424 may be formed by welding. In other implementations, platform 424 may be formed by casting or other manufacturing techniques.

In some implementations, platform 424 provides a surface upon which a person may support his or her weight during standing. In implementations where system 420 is used with an additional lower platform, platform 424 serves as a seat. In implementations where platform 424 serves as a seat, platform 424 may have a smaller outer profile to facilitate seating of a person with his or her feet extending forward of platform 424 for resting upon the additional lower platform. In such implementations, system 420 may additionally comprise a pad, cushion or panel.

Tree mounting arms 426 comprise tubes or bars that are pivotally connected to opposite sides of platform 424 at one end and are configured to be connected to a tree wrapping member 49 (shown in FIG. 1) at the other end. As shown by FIGS. 18 and 19, in the example illustrated, each of such arms 426 comprises hooks 427 to facilitate securement of a tree wrap. Although illustrated as being generally linear, tree mounting arms 426 may have a right different shapes and configurations.

Cross brace 430 comprises a member that extends between and joins tree mounting arms 426. In the example illustrated, cross brace 430 comprises a crossbar 448 and a pair of upstanding posts 449 extending from opposite ends of the crossbar 448 to the tree mounting arms 426. Cross brace 430 supports tree mounting arms 426 in their raised positions shown in FIGS. 14-17. Opposite ends or sides of cross brace 430 are each pivotally connected to respective tree mounting arms 426. A middle portion of cross brace 430, crossbar 448, is pivotally connected to cross brace carriage 432, such as with an axle or pivot pin in the form of a bolt 435. In the example illustrated, tree mounting arms 426 are pivotable relative to platform 424 about axis 445. Cross brace 430 is pivotable relative to tree mounting arms 426 about axis 446 and is pivotal relative to carriage 432 about axis 447. Each of axes 445, 446, and 447 are parallel to one another.

Cross brace carriage 432 comprises a member or mechanism configured to movably carry cross brace 430 relative to platform 424 in forward and rearward directions towards and away from edges 440 and 442, respectively. As indicated above, cross brace carriage 432 is pivotably connected to cross brace 430. Cross brace carriage 432 is guided in the forward direction or the rearward direction by guide 450.

Guide 450 comprises an arrangement of surfaces that engage corresponding surfaces of carriage 432 to restrict or limit movement of carriage 432 in forward and rearward directions. In the example illustrated, guide 450 is in the form of an elongate slot 457 formed in the platform 424 and a shaft associated with or carried by carriage 432, wherein the shaft extends into, and in some implementations, passes through, slot 457. The opposite interior sides of slot 457 restrict lateral movement of the shaft to guide forward and rearward movement of the shaft and that of carriage 432. In the example illustrated, the shaft comprises a threaded bolt 463 which also serves as part of retainer 436. In the example, the threaded bolt to passes through and is threaded to a manually actuatable wing nut knob 465 which may be manually turned to clamp the head of the threaded bolt 463 against surfaces of platform 424 along slot 457 so as to frictionally retain carriage 432 in place along slot 457. Conversely, manual rotation of the wing nut knob 465 may also loosen the bolt 463, permitting carriage 432 and cross brace 430 to be slid along slot 457 between the rearward state or position (shown in FIGS. 14-17) in which cross brace 430 is substantially vertical, supporting tree mounting arms 426 in elevated states and a forward state or position (shown in FIGS. 18 and 19) in which cross brace 430 is collapsed or folded such that system 420 is in a flat substantially flat folded state. The wing nut knob may have a variety of shaped configured to facilitate manual gripping and rotation of the knob.

Although system 420 utilizes wing nut knob 465, in other implementations, other mechanisms may be used to adjust the clamping state of bolt 463. For example, in other implementations, wing nut knob 465 may be replaced with a threaded nut. The bolt and wing nut knob may be replaced with a nut on the underside and a thumb screw extending from the top side and engaging the nut. In some implementations, the bottom side head of the bolt or the bottom side nut may be part of or embedded within a u-shaped member that receives a lower edge of rails projecting on opposite sides of and along the slot, permitting the head or the nut to slide along the slot, but inhibit rotation of the head or nut as the topside wing nut knob 465 or a thumbscrew are being rotated to clamp the carriage at a selected location along the slot.

In some implementations, bolt 463 and wing nut knob 465 may be replaced with a quick release over center cam clamp similar to those found on bicycle seat posts, wherein the shaft of the clamp passes through slot 457, wherein the head of the clamp extends along an underside or top side of platform 424 and wherein the cam extends along the opposite side of platform 424. In such implementations, the over center cam is actuatable to draw the head of the cam mechanism against portions of platform 424 along slot 457. In some implementations, the underside of platform 424 along slot 457 may include notches or detents to tactically indicate one or more recommended positions for carriage 432 along slot 457. For example, the recess, detent or depression may be provided along the lower surface of platform 24 along slot 457 and at a rearward most end of slot 457, wherein the head of bolt 463 may drop or pop into the recess, detent or depression when carriage 432 is at the recommended rearward most position for properly supporting cross brace 430 in the raised operational state. In yet other implementations, retainer 436 may comprise other mechanisms or have other configurations.

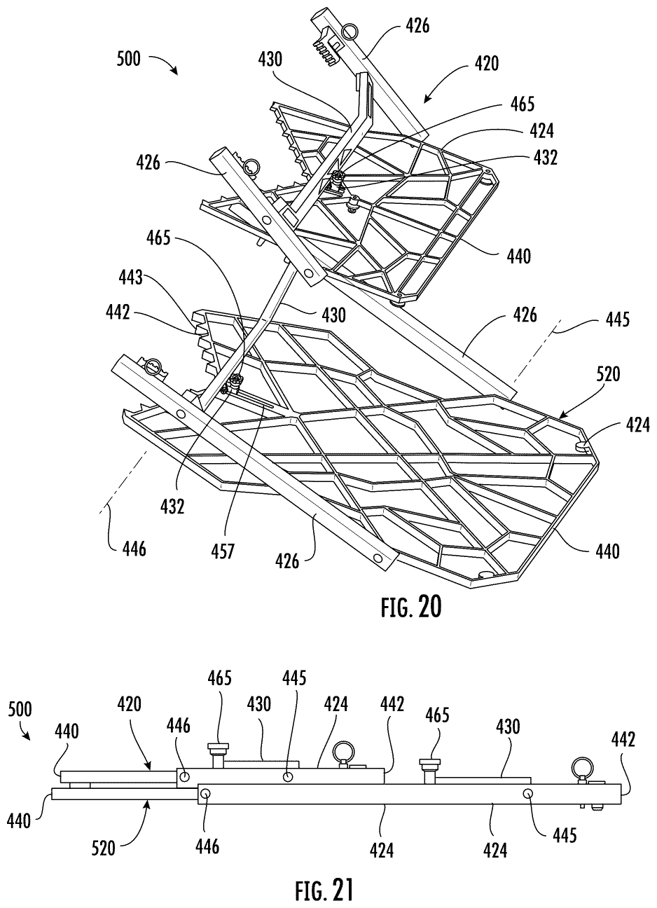

FIGS. 20 and 21 illustrates portions of an example larger two platform flat folding tree stand system 500 which comprises an upper flat folding tree stand system 420 and a lower flat folding tree stand system 520. Upper flat folding tree system 420 is described above and serves as an upper seating surface for a person using system 500. Lower flat folding tree stand system 520 is similar to upper flat folding tree stand system 420 except that its components are longer or more extensive as compared to system 420 such that system 520 projects forwardly beyond the platform 424 of system 420, permitting the person to extend his or her legs forward of platform 424 of system 420 and rest his or her feet upon the platform of system 520. Those parts of system 520 which correspond to parts of system 420, although provided with generally longer dimensions, are numbered similarly. In the example illustrated, platform 424, tree support arms 426 and slot 457 of system 520 are longer than platform 424, tree support arms 426 and slot 457 of system 420. As shown by FIG. 500, the platform 424 of systems 420 and 520 may have different open celled configurations or lattices. In some implementations, the platforms 424 of systems 420, 520 may have other differences. For example, in some implementations, the upper platform 424 of system 420 may be provided with a pad, cushion or panel. In some implementations, one or both of platforms 424 may be imperforate, but for the provision of slots 457.

As shown by FIGS. 20 and 21, both of systems 420 and 520 function similarly in that they may each be moved to extended in use states as shown in FIG. 20 and folded are collapsed to storage or transport states shown in FIG. 21. The collapse or folding of system 520 occurs in a fashion similar to that of system 420 as described above. As shown by FIG. 21, collapsing or folding both of systems 420 and 520 permits the entire larger system 500 to be folded are collapsed to a substantially flat state as shown. As a result, the larger two platform system 500 may be more easily transported, may be more easily shipped (in smaller boxes or packaging) and may be more easily stored or inventoried.

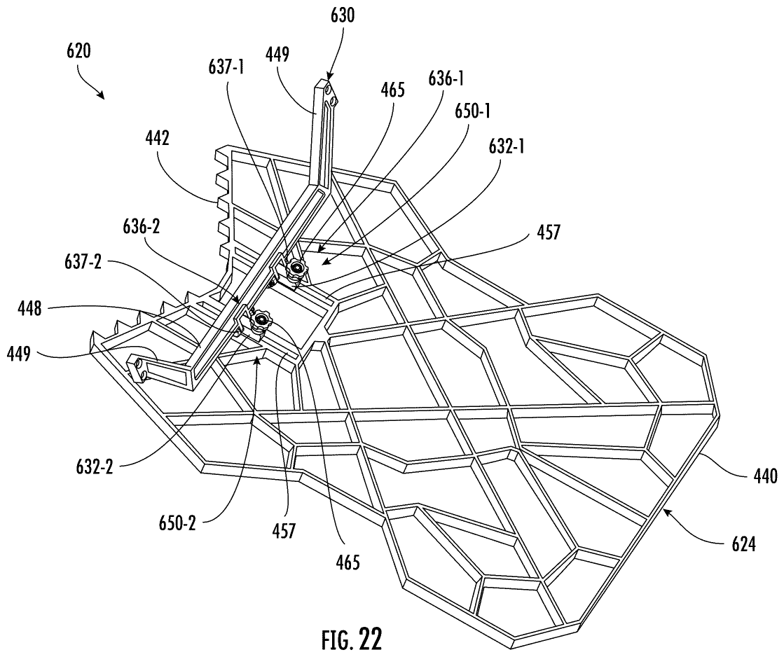

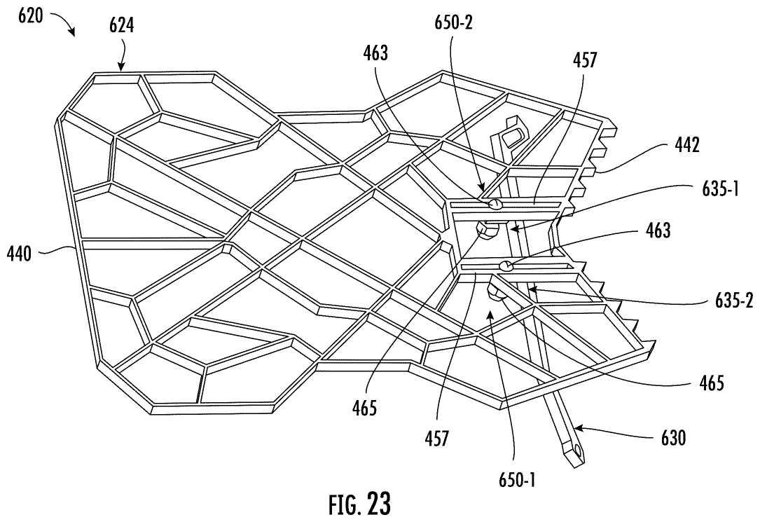

FIGS. 22-24 illustrate portions of an example folding tree stand system 620. System 620 may be utilized in place of system 520 described above as part of system 500. System 620 is similar to system 520 except that system 620 comprises a pair of cross brace carriages, a pair of retainers and a pair of guides (slots and bolts in the example) to provide enhanced guiding of movement of the cross brace and retention of the cross brace and tree stand in either an extended or folded state. The example flat folding tree stand system 620 comprises platform 624, tree mounting arms 426 (shown and described above with respect to FIG. 20), cross brace 630, cross brace carriages 632-1, 632-2 (collectively referred to as carriages 632), and retainers 636-1, 636-2 (collectively referred to as retainers 636. Platform 624 is substantially similar to platform 424 except that platform 624 comprise a pair slots 457, instead of a single slot 457, for forming part of guides 650. Platform 624 comprises a structure having a substantially flat upper surface. Platform 424 has a front edge 440 and a rear edge 442. Rear edge 442 may be configured or shaped so as to abut against the generally circumferential profile of a tree trunk or branch 44 (shown in broken lines in FIGS. 1 and 2). In the example illustrated, rear edge 442 is concave for receiving a portion of tree 44. In some implementations, rear edge 442 has a V-shaped recess as shown. In the illustrated example, rear edge 442 is provided with a series of teeth for 43 for the gripping of tree 44.

In some implementations, platform 624 may be formed from a metal, such steel or aluminum. In the example illustrated, platform 624 is perforated or comprises a network, grid or lattice of rods or bars such that a majority of the platform 624 is perforated or open celled to reduce weight. In some implementations, platform 624 may be formed by welding. In other implementations, platform 624 may be formed by casting or other manufacturing techniques.

In some implementations, platform 624 provides a surface upon which a person may support his or her weight during standing. In implementations where system 620 is used with an additional lower platform, platform 624 serves as a seat. In implementations where platform 624 serves as a seat, platform 624 may have a smaller outer profile to facilitate seating of a person with his or her feet extending forward of platform 624 for resting upon the additional lower platform. In such implementations, system 620 may additionally comprise a pad, cushion or panel.

Tree mounting arms 426 comprise tubes or bars that are pivotally connected to opposite sides of platform 624 at one end and are configured to be connected to a tree wrapping member 49 (shown in FIG. 1) at the other end. As shown by FIGS. 18 and 19, in the example illustrated, each of such arms 426 comprises hooks 427 to facilitate securement of a tree wrap. Although illustrated as being generally linear, tree mounting arms 426 may have a right different shapes and configurations.

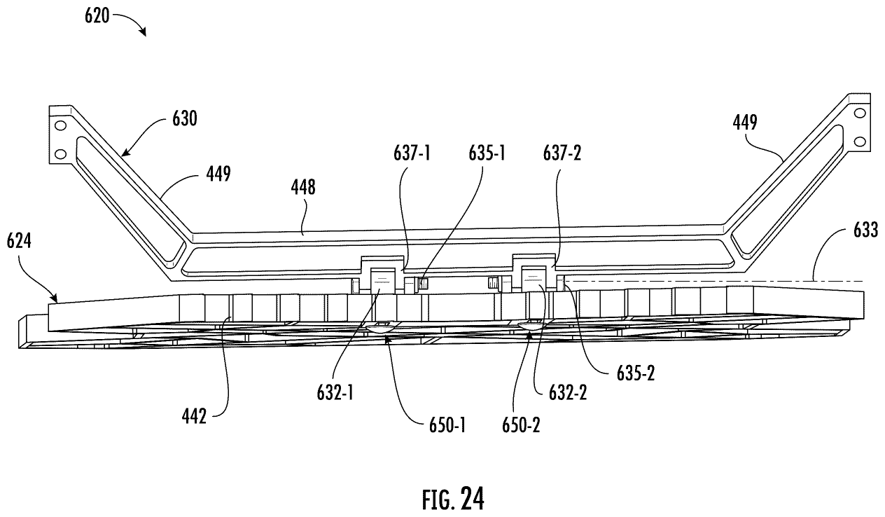

Cross brace 630 is similar to cross brace 430 except the cross brace 630 comprises a pair of downwardly projecting cleavages 637-1, 637-2 (shown in FIG. 24) for pivotably connecting cross brace 630 to cross brace carriages 632-1, 632-2, respectively. As with cross brace 430, cross brace 630 comprises a member that extends between and joins tree mounting arms 426. In the example illustrated, cross brace 630 brace comprises a crossbar 448 and a pair of upstanding posts 449 extending from opposite ends of the crossbar 448 to the tree mounting arms 426. Cross brace 630 supports tree mounting arms 426 in their raised positions shown in FIG. 24. Opposite ends or sides of cross brace 630 are each pivotally connected to respective tree mounting arms 426. As shown by FIG. 24, central portions of cross brace 630, crossbar 448, are pivotally connected to cross brace carriage carriages 2-1 and 632-2, such as with axles or pivot pins in the form of a bolts 635-1, 635-2 passing through clevises 637-1 and 637-2, respectively (shown in FIG. 24). In the example illustrated, tree mounting arms 426 are pivotable relative to platform 424 about axis 445. Cross brace 630 is pivotable relative to tree mounting arms 426 about axis 446 and is pivotal relative to carriages 632 about axis 633. Each of axes 445, 446 and 633 are parallel to one another.

Cross brace carriages 632 comprises members or mechanisms configured to movably carry cross brace 630 relative to platform 624 in forward and rearward directions towards and away from edges 440 and 442, respectively. As indicated above, cross brace carriage 632 is pivotably connected to cross brace 630. Cross brace carriages 632 are guided in the forward direction or the rearward direction by guides 650.

Each of guides 650 comprises an arrangement of surfaces that engage corresponding surfaces of carriages 432 to restrict or limit movement of carriages 632 in forward and rearward directions. In the example illustrated, guides 650 are each in the form of an elongate slot 457 formed in the platform 624 and a shaft associated with or carried by carriage 632, wherein the shaft extends into, and in some implementations, passes through, a corresponding slot 457. The opposite interior sides of each slot 457 restrict lateral movement of the shaft to guide forward and rearward movement of the shaft and that of the respective carriage 632-1, 631-2. In the example illustrated, the shaft comprises a threaded bolt 463 which also serves as part of a respective one of retainers 636. In the example, the threaded bolt to readily engages in passes through a manually actuatable wing nut knob 465 which may be manually turned to clamp the head of the threaded bolt 463 against surfaces of platform 624 along slot 457 so as to frictionally retain carriages 632 in place along slots 457. Conversely, manual rotation of the wing nut knobs 465 may also loosen the bolts 463, permitting carriages 632 and cross brace 630 to be slid along slots 457 between the rearward state or position in which cross brace 430 is substantially vertical, supporting tree mounting arms 426 in elevated states and a forward state or position in which cross brace 630 is collapsed or folded such that system 620 is in a flat substantially flat folded state. Although system 620 utilizes wing nut knobs 465, in other implementations, other mechanisms may be used to adjust the clamping state of bolts 463. For example, in other implementations, wing nut knob 465 may be replaced with a threaded nut.

In some implementations, bolts 463 and wing nut knobs 465 may each be replaced with a quick release over center cam clamp similar to those found on bicycle seat posts, wherein the shaft of the clamp passes through slot 457, wherein the head of the clamp extends along an underside or top side of platform 424 and wherein the cam extends along the opposite side of platform 424. In such implementations, the over center cam is actuatable to draw the head of the cam mechanism against portions of platform 424 along slot 457. In some implementations, the underside of platform 624 along slot 457 may include notches or detents to tactically indicate one or more recommended positions for carriage 632 along slots 457. For example, the recesses, detents or depressions may be provided along the lower surface of platform 624 along slots 457 and at a rearward most end of each of slots 457, wherein the head of each of bolts 463 may drop or pop into the recess, detent or depression when carriage 632 is at the recommended rearward most position for properly supporting cross brace 630 in the raised operational state. In yet other implementations, retainers 636 may comprise other mechanisms or have other configurations.

Although the present disclosure has been described with reference to example implementations, workers skilled in the art will recognize that changes may be made in form and detail without departing from the disclosure. For example, although different example implementations may have been described as including features providing various benefits, it is contemplated that the described features may be interchanged with one another or alternatively be combined with one another in the described example implementations or in other alternative implementations. Because the technology of the present disclosure is relatively complex, not all changes in the technology are foreseeable. The present disclosure described with reference to the example implementations and set forth in the following claims is manifestly intended to be as broad as possible. For example, unless specifically otherwise noted, the claims reciting a single particular element also encompass a plurality of such particular elements. The terms “first”, “second”, “third” and so on in the claims merely distinguish different elements and, unless otherwise stated, are not to be specifically associated with a particular order or particular numbering of elements in the disclosure.

What is claimed is:

1. A flat folding tree stand system for mounting to a tree, the system comprising:
a platform;
tree mounting arms pivotably connected to opposite sides of the platform and extending rearwardly;
a cross brace having opposite end portions pivotably connected to the tree mounting arms;
a cross brace carriage pivotably connected to a midportion of the cross brace and movably coupled to the platform for forward and rearward movement along the platform; and
a retainer to selectively secure the cross brace carriage at a forward position with the cross brace in a lower retracted state and a rearward position with the cross brace in a raised extended state.

2. The system of claim 1, wherein the platform comprises a guide along which the cross brace carriage moves.

3. The system of claim 2, wherein the guide extends along a first axis, wherein the cross brace is pivotably connected to the cross brace carriage for pivotable movement about a second axis perpendicular to the first axis and wherein the cross brace is pivotably connected to the tree mounting arms for pivotable movement about a third axis parallel to the second axis.

4. The system of claim 2, wherein the guide comprises a slot in the platform and wherein b slides rearwardly and forwardly within the slot.

5. The system of claim 4, wherein the cross brace carriage is at a rearward position in the slot when the cross brace is in the raised extended state.

6. The system of claim 4, wherein the slot extends along a first axis, wherein the cross brace is pivotably connected to the cross brace carriage for pivotable movement about a second axis perpendicular to the first axis and wherein the cross brace is pivotably connected to the tree mounting arms for pivotable movement about a third axis parallel to the second axis.

7. The system of claim 4, wherein the retainer comprises a threaded bolt passing through the slot and a threaded nut on the threaded bolt, the threaded nut being movable along the threaded bolt to a position securing the cross brace carriage at the selected one of a plurality of positions along the slot.

8. The system of claim 7, further comprising a second guide and a second retainer, wherein the second guide comprises a second slot in the platform parallel to the slot and wherein the second retainer comprises a second threaded bolt passing through the second slot and a second threaded nut of the second threaded bolt, the second threaded nut being movable along the second threaded bolt to a position securing the cross brace carriage at the selected one of the plurality of positions along the second slot.

9. The system of claim 4, wherein the cross brace comprises a crossbar and a pair of upstanding posts extending from opposite ends of the crossbar to the opposite end portions.

10. The system of claim 9, wherein the platform extends in a first plane and wherein the cross brace is pivotable to the lowered retracted state in which the pair of upstanding posts lie within a second plane parallel to the first plane.

11. The system of claim 10, wherein the pair of upstanding posts lie within a third plane perpendicular to the first plane when the cross brace is in the raised extended state.

12. The system of claim 1, wherein the tree mounting arms each comprise linear rigid posts, each of the linear rigid posts having a first end pivotably connected to one of the opposite sides of the platform, and a second end having a connector for connection to a flexible line for being wrapped about a tree, wherein the cross brace is pivotably connected to a portion of each of the rigid linear posts between the first end and the second end.

13. The system of claim 12, wherein the connector comprises a hook.

14. The system of claim 1, wherein the platform comprises a rear facing V-shaped notch lined with teeth.

15. The system of claim 1 further comprising:
a second platform for being mounted to a tree over and above the platform;
second tree mounting arms pivotably connected to opposite sides of the second platform and extending rearwardly;
a second cross brace having opposite end portions pivotably connected to the tree mounting arms; and
a second cross brace carriage pivotably connected to a midportion of the second cross brace and movably coupled to the second platform for forward and rearward movement; and
a second retainer to selectively secure the second cross brace carriage at a forward position with the second cross brace in a lower retracted state and a rearward position with the second cross brace in a raised extended state.

16. The system of claim 1, wherein the platform comprises a guide along which the cross brace carriage is movable and wherein the retainer comprises:
a detent along the guide; and
a projection coupled to the cross brace carriage and removably received within the detent to secure the cross brace carriage at a selected position along the guide.

17. The system of claim 1, wherein the cross brace comprises a crossbar and a pair of upstanding posts extending from opposite ends of the crossbar to the opposite end portions.

18. The system of claim 17, wherein the platform extends in a first plane and wherein the cross brace is pivotable to the lowered retracted state in which the pair of upstanding posts lie within a second plane parallel to the first plane.

19. The system of claim 18, wherein the pair of upstanding posts lie within a third plane perpendicular to the first plane when the cross brace is in the raised extended state.

20. The system of claim 1, wherein the platform comprises a guide along which the cross brace carriage is movable, the guide comprising a bar about which the cross brace carriage extends and along which the cross brace carriage slides.
